(19) United States
(12) Patent Application Publication
(10) Pub. No.: US 2019/0072981 A1
(43) Pub. Date: Mar. 7, 2019

(54) METHOD FOR CONTROLLING THE CIRCULATION OF VEHICLES IN A NETWORK

(71) Applicant: ALSTOM Transport Technologies, SAINT-OUEN (FR)

(72) Inventors: Mathieu BRESSON, PARIS (FR); Javier BALLESTEROS, PARIS (FR)

(21) Appl. No.: 16/118,122

(22) Filed: Aug. 30, 2018

(30) Foreign Application Priority Data
Sep. 1, 2017 (FR) 17 58096

(51) Int. Cl. G05D 1/02; G05D 1/00; B60W 30/16; B60W 50/08; G06K 9/00

(52) U.S. Cl. CPC G05D 1/0293; G05D 1/0088; G05D 1/0289; G05D 2201/0213; B60W 50/082; G06K 9/00825; B60W 30/16

(57) ABSTRACT

The invention relates to a method for controlling the circulation of vehicles in a network controlled by a control system managing the circulation of communicating vehicles according to a first mode, the first mode managing the movement of the communicating vehicle toward the end terminal of a first section in which a non-communicating vehicle has been detected by implementing a discrimination step eliminating any protection zone located the moving vehicle, when a distance between the communicating vehicle and said end terminal is smaller than a threshold, the method comprising switching into a second mode, when the communicating vehicle enters the first section, the second mode inhibiting the implementation of the discrimination step at least in the first section.

### BACKGROUND OF THE INVENTION

The present invention relates to a method for controlling the circulation of vehicles in a network. The present invention also relates to an associated assembly.

Many transportation networks are equipped with systems for controlling the circulation of vehicles, in particular railway vehicles, for example, of the rubber-tired subway or rail subway type. Such systems for controlling circulation make it possible to identify the presence and position of vehicles in the network and to control their movement, in particular so as to limit the risk of accidents. To that end, circulation systems frequently include detectors for detecting the presence of a vehicle in a section of the network.

It is also known to use networks equipped with a CBTC (Communication-Based Train Control) signaling system, which controls the circulation of a railway vehicle, such as a subway, in a network, along routes that are drawn by an Automatic Train Supervision (ATS) system and opened by a Computer-Based Interlocking (CBI) system.

The signaling system in particular includes a system for managing the presence of railway vehicles circulating on the network.

The network is for example subdivided into sections, each section extending between two signaling signals and advantageously being subdivided into a plurality of zones. One section is advantageously traveled by a vehicle in a predetermined nominal circulation direction.

In such networks, so-called equipped or communicating vehicles circulate, for example automatically piloted vehicles. The communicating vehicles generally comprise devices making it possible to evaluate the position of the vehicle in the network and communicate it to the management system. The management system then checks the presence and position of the communicating vehicles in the network based on the position evaluated by the vehicles and the knowledge of the dimensions of the communicating vehicles. Thus, the occupancy of the various sections of the network is optimized, which makes it possible to decrease the transport time over the entire network.

However, these transportation networks are configured to allow the simultaneous circulation over the network of the communicating vehicles, but also of so-called non-equipped or non-communicating vehicles. Non-communicating vehicles do not comprise devices making it possible to evaluate their position and send it to the management system or comprise such devices, but said devices are inactive. For example, non-communicating vehicles are used for the upkeep of the tracks and transport of personnel in case of operations on the tracks. It is difficult for the management system to account for the presence of these non-communicating vehicles in an optimal manner while guaranteeing optimal operating safety.

In particular, the management system defines protection zones around each communicating and non-communicating vehicle detected in the network, prohibiting the movement of another vehicle in this protection zone. However, for the non-communicating vehicles, it is not possible to make a precise determination of the position of the non-communicating vehicle in a section, and the associated protection zones have large dimensions (generally at least as large as the section), while the non-communicating vehicles generally have smaller dimensions than the communicating vehicles, which are generally used to transport travelers.

Furthermore, the presence of protection zones is difficult to manage and presents safety problems in some cases, in particular when communicating and non-communicating vehicles are stored in a same section, at night for example, or travel over a same section or in successive sections.

There is therefore a need for a method for controlling the circulation of vehicles in a network that is more optimized, in particular in terms of safety, while guaranteeing optimal operation of the network, in particular optimal circulation of the vehicles in the network.

### BRIEF SUMMARY OF THE INVENTION

To that end, proposed is a method for controlling the circulation of communicating and non-communicating vehicles in a network, the network comprising tracks divided into a set of sections, each delimited by two end terminals, beacons and track sensors, the set of track sensors forming a secondary detection system, each communicating vehicle being provided with an active on board position detection device, called primary detection device, the primary detection device forming, with the beacons, a primary detection system, each non-communicating vehicle being a vehicle with no primary detection device. The network is controlled by a control system able to manage the circulation of the communicating vehicles on each section according to a first operating mode, associating a first protection zone with each communicating vehicle, the location of the first protection zone depending on a position of the communicating vehicle defined by the primary detection system, and associating a second protection zone with each non-communicating vehicle, the location of the second protection zone depending on a position of the non-communicating vehicle defined by the secondary detection system, the first operating mode managing the movement of the communicating vehicle toward the end terminal of a first section in which a non-communicating vehicle has been detected by implementing a discrimination step, the discrimination step eliminating any protection zone located between the communicating vehicle and one of the end terminals of a free vehicle section toward which the communicating vehicle moves, when a distance between the communicating vehicle and said end terminal is smaller than or equal to a predetermined threshold, the method comprising a step for switching the control system into a second operating mode, when the communicating vehicle enters the first section, the second operating mode inhibiting the implementation of the discrimination step at least in the first section.

The present description also describes a method for controlling the circulation of vehicles in a network, the network comprising tracks divided into a set of sections each delimited by two end terminals, beacons and track sensors, the set of track sensors forming a secondary detection system, the network being controlled by a control system able to manage the circulation of communicating vehicles according to a first operating mode, each communicating vehicle being provided with an active on board position detection device, called primary detection device, the primary detection device forming a primary detection system with the beacons, the first operating mode managing the movement of the communicating vehicle toward the following terminal of a first section in which a non-communicating vehicle has been detected by implementing a discrimination step, a non-communicating vehicle being a vehicle with no active position detection primary device, the non-communicating vehicle being associated with a protection zone defined by the secondary detection system and having an initial length, the discrimination step eliminating the protection zone when a distance between the communicating vehicle and the terminal of the first section is smaller than or equal to a predetermined threshold, the method comprising a step for switching into a second operating mode when the communicating vehicle enters the first section, the second operating mode inhibiting the implementation of the discrimination step.

According to specific embodiments, the method has one or more of the following features, considered alone or according to any technically possible combinations:
the second protection zone associated with each non-communicating vehicle includes the first section in which the non-communicating vehicle was detected.
a minimum length is defined for the set of communicating vehicles, the predetermined threshold being below the minimum length.
during the movement of the communicating vehicle, the length of the second protection zone is modified when the distance between an upstream end terminal of the first section and the communicating vehicle is smaller than the length of the second protection zone, the modification making the length of the second protection zone smaller than or equal to a final distance between a downstream end terminal and the communicating vehicle and larger than the length of the non-communicating vehicle.
in the second operating mode, when the communicating vehicle leaves the first section, the length of the protection zone is brought back to an initial length and the method comprises a step for switching from the second operating [mode] to the first operating mode.
a downstream end terminal of the first section delimits the first section and a second section, no vehicle having been detected in the second section, or delimits an end of a track.
the non-communicating vehicle has a length smaller than or equal to half of a length of the communicating vehicle.
the first and second operating modes are managed section by section.

Also proposed is an assembly made up of a network, at least one communicating vehicle and at least one non-communicating vehicle, the network comprising tracks divided into a set of sections each delimited by two end terminals, beacons and track sensors, the set of track sensors forming a secondary detection system, each communicating vehicle being provided with an active onboard position detection device, called primary detection device, the primary detection device forming, with the beacons, a primary detection system, each non-communicating vehicle being a vehicle with no primary detection device, the network being controlled by a control system able to manage the circulation of the communicating vehicles on each section according to a first operating mode, associating a first protection zone with each communicating vehicle, the location of the first protection zone depending on a position of the communicating vehicle defined by the primary detection system, and associating a second protection zone with each non-communicating vehicle, the location of the second protection zone depending on a position of the non-communicating vehicle defined by the secondary detection system, the first operating mode managing the movement of the communicating vehicle toward the end terminal of a first section in which a non-communicating vehicle has been detected by implementing a discrimination step, the discrimination step eliminating any protection zone located between the communicating vehicle and one of the end terminals of a free vehicle section toward which the communicating vehicle moves, when a distance between the communicating vehicle and said end terminal is smaller than or equal to a predetermined threshold, the control system being configured to switch into a second operating mode, when the communicating vehicle enters the first section, the second operating mode inhibiting the implementation of the discrimination step at least in the first section.

According to one specific embodiment, the control system comprises a supervision system, the supervision system providing the switching into a second operating mode when the communicating vehicle enters the first section.

### BRIEF DESCRIPTION OF THE DRAWINGS

Features and advantages of the invention will appear more clearly upon reading the following description, provided solely as a non-limiting example, and done in reference to the appended drawings, in which:

FIG. 1 is a schematic illustration of a network equipped with a CBTC signaling system able to carry out an example method for controlling the circulation of vehicles;

FIG. 2 is a schematic illustration of a communicating vehicle in the network of FIG. 1;

FIG. 3 is a schematic illustration of the communicating vehicle of FIG. 2 in another position in the network; and

FIGS. 4 to 7 are schematic illustrations of the communicating vehicle of FIG. 2 and of a non-communicating vehicle in the network of FIG. 1, the communicating vehicle occupying different positions in the network.

### DETAILED DESCRIPTION OF THE INVENTION

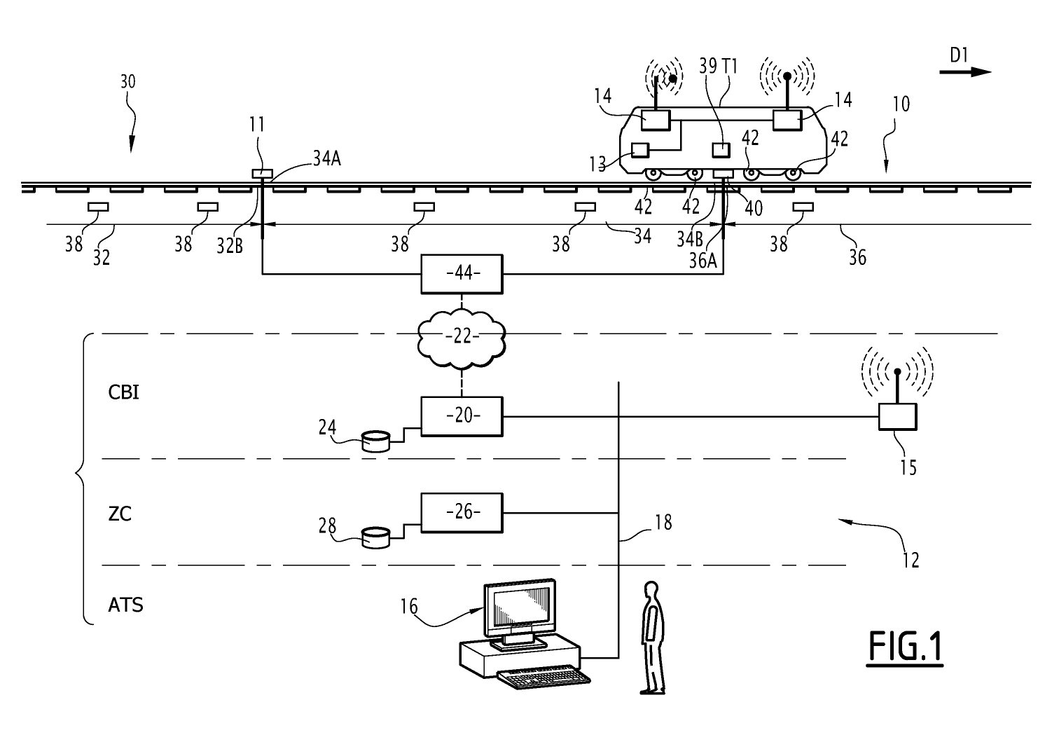

FIG. 1 shows a network 10 equipped with a signal control system 12 based on an ATC (Automatic Train Control) architecture of the Communication-Based Train Control (CBTC) type. A CBTC architecture is based on the presence of computers 13 onboard the trains. A vehicle T1 comprising such an onboard computer is called “communicating vehicle”.

In the control system 12, the onboard computer 13 of a communicating vehicle T1 on the one hand provides coverage for the functional needs of the communicating vehicle T1, and on the other hand, safety point control. The coverage of the functional needs of the communicating vehicle T1 for example provides the stations to be served, while safety point control makes it possible to verify that the communicating vehicle T1 is not speeding at any particular mileage point of the line.

The on board computer 13 of the communicating vehicle T1 determines a certain number of operating parameters of the communicating vehicle T1 and communicates with various systems on the ground to allow the communicating vehicle T1 to perform its assigned mission safely.

The on board computer 13 is at least connected to an onboard radio communication unit 14, able to establish a radio link with base stations 15 of a communication infrastructure on the ground, which in turn is connected to a communication network 18 of the CBTC architecture.

On the ground, the control system 12 includes an interlocking system 20, also called CBI (Computer-Based Interlocking). The interlocking system 20 is able to control the trackside equipment, such as signal lights, switching actuators, etc., this equipment allowing the trains to move safely while avoiding conflicting movements between them. Once based on electromechanical relays, today the interlocking system is computerized by suitable computers. The interlocking system 20 is situated away from the equipment of the track and is connected thereto by a suitable communication network 22, preferably of the ETHERNET type. In FIG. 1, the interlocking system 20 includes a memory 24, in particular for storing information relative to the sub-routes.

The control system 12 comprises a zone controller (ZC) 26, also called system for managing the presence of vehicles circulating on the network. The zone controller 26 is in particular responsible on the one hand for monitoring the presence of the vehicles on the railroad network, and on the other hand, in a centralized architecture, for providing movement authorizations to the vehicles. These movement authorizations must guarantee the safe movements of the vehicles, i.e., for example not give a movement authorization to a vehicle that would cause it to go past a vehicle preceding it. In FIG. 1, the zone controller 26 comprises a memory 28, in particular for storing information relative to the obstacles to be taken into account in determining movement authorizations, and a management unit, such as a computer, not shown, able to carry out programming software instructions stored in the memory 28.

The control system 12 also comprises an automatic train supervision (ATS) system 16. The supervision system 16 is implemented in an operational unit and comprises man/machine interfaces, allowing operators to intervene on the various components of the control system 12.

The network 10 is a transportation network configured to allow the circulation of a set of vehicles T1, T2.

Among this set of vehicles T1 and T2, at least one vehicle is a communicating vehicle T1, i.e., a vehicle that is able to evaluate its position in the network and sending it to the zone controller 26. The set of vehicles T1 and T2 comprises at least one so-called non-communicating vehicle T2, in that the non-communicating vehicle T2 does not comprise a device making it possible to evaluate its position and send it to the zone controller 26 or the non-communicating vehicle T2 includes such a device that is inactive.

In particular, the network 10 is suitable for the circulation of a set of communicating vehicles T1 and at least one non-communicating vehicle T2.

The network 10 comprises tracks 30.

Each track 30 is suitable for allowing the circulation of the vehicles T1, T2. For example, each track 30 is provided to allow the circulation of the vehicles T1, T2 along a predetermined direction.

Alternatively, some tracks 30 are two-way tracks.

According to the example of FIG. 1, the network 10 is a railway network. Each track 30 is then a railroad track.

For example, the network 10 is an underground railway transport network, such as a subway.

Alternatively, the network 10 is a surface railway transport network, such as a tram network or a train network or an overhead railway.

Each track 30 is subdivided into sections 32, 34, 36.

In FIG. 1, three successive sections 32, 34, 36 are shown. The sections 32, 34, 36 are advantageously traveled by a vehicle along a predefined nominal circulation direction D1.

Therefore, hereinafter, each section 32, 34, 36 is referred to in order in the nominal direction of circulation D1. Thus, section 32 is called first section 32, section 34 is called second section 34 and section 36 is called third section 36.

Each section 32, 34, 36 extends between two end terminals: an upstream end terminal 32A, 34B, 36A and a downstream end terminal 32B, 34A, 36B. Some end terminals 32A, 34B, 36A, 32B, 34A, 36B are associated with a signaling signal, for example a signal light, not shown. The names “downstream” and “upstream” should be understood along the nominal circulation direction D1, upstream thus being located to the left in FIG. 1, while downstream is located to the right in FIG. 1.

Advantageously, the track 30 includes, at each border between two sections 32, 34, 36, an end terminal 32A, 34B, 36A, 32B, 34A, 36B. In other words, the first upstream end terminal 32B and the second downstream end terminal 34A, respectively the second downstream end terminal 34B and the third upstream end terminal 36A are combined.

Advantageously, each section 32, 34, 36 is subdivided into a plurality of zones.

Each section 32, 34, 36 has a section length Ls. The section length Ls is comprised between 100 meters (m) and 1 kilometer (km).

The occupancy of a section 32, 34, 36 and advantageously a zone is a key piece of information for railway safety. The determination of this information will now be generally described.

In the example of FIGS. 1 to 3, the communicating vehicles T1 include the on board computer 13, able to detect beacons 38 installed along the track 30 and the geographical positions of which are known, and odometry sensors 39 allowing the on board computer 13 to determine the distance traveled since the last beacon 38 crossed.

The on board computer 13 is able to determine the position of the corresponding communicating vehicle T1 based on the beacons 38 that the communicating vehicle T1 has detected and measurements taken by the odometry sensors 39.

Each communicating vehicle T1 has a first length L1. According to one embodiment, the first length L1 is the same for each communicating vehicle T1.

A minimum length Lm is defined for all of the communicating vehicles T1 as being the length of the smallest of the communicating vehicles T1 of the set of communicating vehicles.

The minimum length Lm is for example comprised between 20 m and 100 m.

According to one particular embodiment, the minimum length Lm is equal to 30 m.

When the first length L1 is identical for each communicating vehicle T1, the minimum length Lm is equal to the first length L1.

The on board computer 13, the beacons 38 and the odometry sensors 39 form a primary detection system for detecting the position of a vehicle, this primary detection system being associated with each communicating vehicle T1.

The primary detection system determines the section, advantageously the zone, occupied by a communicating vehicle T1 from the instantaneous position of the communicating vehicle T1 calculated by the computer 13 on board the latter. For example, this position is determined by the on board computer 13 from the detection of beacons 38 installed along the track and whose geographical positions are known, and from measurements delivered by odometry sensors 39 equipping the communicating vehicle T1 and allowing the on board computer 13 to determine the distance traveled since the last beacon 38 crossed.

The primary detection system is able to communicate with the zone controller 26.

The non-communicating vehicles T2 generally have no on board computer able to communicate with the beacons 38 of the primary detection system.

According to one embodiment, the non-communicating vehicle T2 is a maintenance vehicle intended to be used by the maintenance staff of the network 10.

Alternatively, a communicating vehicle T1 for which the primary detection system is inactive following a malfunction or following a prolonged stop of the vehicle is considered to be a non-communicating vehicle T2.

Each non-communicating vehicle T2 has a second length L2.

In the described example, the second length L2 is strictly less than the first length L1.

For example, the second length L2 is less than or equal to half the first length L1.

One typical example of a second length L2 is 3 meters.

The network 10 also includes a secondary detection system for detecting the position of the set of vehicles, i.e., communicating T1 and non-communicating vehicles T2 circulating on the network 10.

The secondary detection system comprises sensors on the track 40. The secondary detection system is able to detect the presence of a vehicle in a section. As shown in FIG. 1, these sensors on the track 40 may be axle counters located at each end of a section, like the second section 34. Thus, when the communicating vehicle T1 enters the second section 34, the upstream sensor 40 (in the nominal circulation direction D1) allows the incrementation by one unit of a state counter associated with the second section 34, each time the passage of an axle 42 of the communicating vehicle T1 is detected. When the communicating vehicle T1 leaves the second section 34, the downstream sensor 40 makes it possible to decrement the same state counter by one unit, each time the passage of an axle 42 of the communicating vehicle T1 is detected. Thus, the second section 34 is in the “free” state when the associated state counter is equal to zero. Otherwise, the second section 34 is in the “occupied” state.

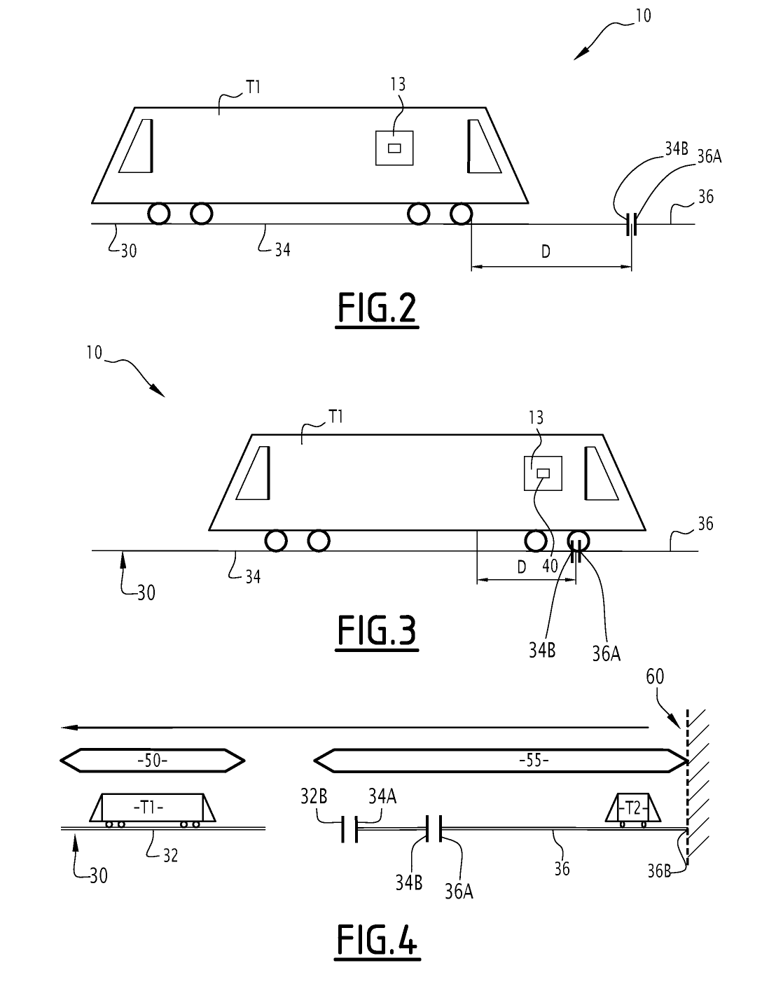

In the example of FIG. 2, the secondary detection system includes axle sensors 40 that each delimit two adjacent sectors and that are able to detect the passage of a vehicle.

The network 10 for example includes an axle sensor for each pair of adjacent end terminals.

More generally, the secondary detection system defines the subdivision of the track into sections and is able to determining an occupancy state of each section.

Advantageously, the secondary detection system defines the subdivision of the track into zones and is able to determine an occupancy state of each zone.

In another embodiment, these sensors are “track circuits” making it possible to detect the presence of a short circuit between the lines of rails caused by the presence of the axle of a vehicle. In this embodiment, a track circuit is for example associated with each section 34, 36, 38 and the rails of the adjacent sections are electrically isolated from one another by isolation joints positioned at the ends of each section.

In these two embodiments, the secondary detection system comprises, aside from a plurality of sensors 40, a plurality of intermediate equipment items 44 making it possible to use analog measurement signals at the output of the sensors 40 to generate occupancy information. This is sent via the network 22 to the interlocking system 20, then to the zone controller 26.

The primary detection system makes it possible to determine the position of the communicating vehicles T1 with a better precision than the precision provided by the secondary detection system.

The zone controller 26 receives information on the one hand from the primary detection system, and on the other hand from the secondary detection system, and reconciles this information to determine the occupied and free zones of the network 10.

From the instantaneous position sent by each on board computer 13 of the primary detection system, the zone controller 26 determines, using a geographical map of the network 10 identifying each section, advantageously each zone, uniquely, the section, advantageously the zone, within which the communicating vehicle T1 is located. The section, advantageously the zone is then placed in the “occupied” state.

It should be noted that a same section, advantageously a same zone, may be occupied by several vehicles.

More specifically, from the instantaneous position, the zone controller 26 is able to determine an imprint of the communicating vehicle T1 on the network 10, and in particular a first protection zone 50 associated with the corresponding communicating vehicle T1 inside which no other vehicle is authorized to enter. The first protection zone 50 moves based on the instantaneous position of the vehicle. Such a first protection zone 50 in particular makes it possible to avoid any risk of collision with communicating vehicles T1.

The secondary detection system makes it possible to guarantee redundancy relative to the primary detection system, for example in the case where the communication unit 14 of a vehicle T1 is no longer working and the zone controller 26 can no longer obtain the instantaneous position of the vehicle.

The secondary detection system is also able to support the primary detection system to determine the section, advantageously the zone, occupied by each non-communicating vehicle T2. While a “purely CBTC” system can operate only with the primary detection, a secondary detection system is necessary on the one hand to cover the failure modes of the ground on-board communication for a communicating vehicle T1, and on the other hand to allow the circulation on the network 10 of non-communicating vehicles, i.e., that are not equipped with an onboard computer compatible with the CBTC architecture.

From the section occupied by each non-communicating vehicle T2, sent by the secondary detection system, the zone controller 26 is able to determine the section within which each non-communicating vehicle T2 is located. The section is then placed in the “occupied” state.

More specifically, from the section occupied by a non-communicating vehicle sent by the secondary detection system, the zone controller 26 is able to determine a second protection zone 55 associated with the corresponding vehicle within which no other vehicle is authorized to enter. The second protection zone 55 moves based on the section(s) occupied by the non-communicating vehicle T2. Such a second protection zone 55 makes it possible, with the first protection zone 50, to avoid any risk of collision between communicating T1 and/or non-communication T2 vehicles.

The second protection zone 55 is generally larger than the first protection surface 50. The second protection zone 55 for example covers a distance larger than or equal to the set of sections occupied by a non-communicating vehicle T2, when the non-communicating vehicle T2 is the only one to occupy said set.

The first protection zone 50 generally covers a distance equal to the length of the communicating train T1 with which it is associated, to which a margin of error is added, visible in FIG. 4. The margin of error for example depends on the speed of the vehicle and/or the precision of the odometry sensors 39.

In other words, the zone controller 26 is able to determine a piece of occupancy information of each section and storing it in the memory 28, and determining a first protection zone 50 for each communicating vehicle T1 and a second protection zone 55 for each non-communicating vehicle T2. The zone controller 26 is configured to control the movement of the vehicles relative to one another based on routes to be followed sent by the supervision system 16 and the position of the different protection zones 50 and 55.

Thus, the management of the size and position of the protection zones 50, 55 makes it possible to control the movement of the vehicles T1, T2 relative to one another and to avoid any collision risk.

The zone controller 26 includes a management unit, not shown, for the first and second protection zones 50, 55 in each track section. The management unit is able to determine the protection zone associated with each vehicle and modifying the position of the protection zones in the network based on the position of the vehicles detected by the primary and secondary detection systems.

The zone controller 26, and in particular the management unit, is able to operate according to a first operating mode M1 and a second operating mode M2.

In the first operating mode M1, said to be with discrimination, when the distance between a communicating vehicle T1 and an end terminal, comprised between a first section where the communicating vehicle T1 is located and a second, unoccupied section, is smaller than a predetermined threshold, any second protection zone 55 extending between the communicating vehicle T1 and said end terminal is eliminated. Such a second protection zone 55 has for example been generated in error by the zone controller 26 due to incorrect information sent by the axle sensors 40 or is related to the presence of a non-communicating vehicle T2 between the communicating vehicle T1 and the considered end terminal.

The end terminal is for example a track end terminal as shown in FIGS. 4 to 7 or an end terminal at the border between two sections.

The predetermined threshold is for example less than or equal to the minimum length Lm.

The predetermined threshold is often calculated as the minimum distance Lm minus the distance that a potential non-communicating vehicle may travel in the following section before the computer 26 may have detected the occupancy of this following section.

In the second operating mode M2, said to be without discrimination, the first operating mode M1 is deactivated.

The supervision system 16 is able to command the operation of the management unit according to the first operating mode or the second operating mode.

Advantageously, the supervision system 16 is able to command the operation of the management unit according to the first operating mode M1 in a first set of sections and according to the second operating mode M2 in a second set of sections.

Also advantageously, the supervision system 16 is able to command the operation of the management unit according to the second operating mode M2 only in the zones or sections where a non-communicating vehicle, such as the maintenance vehicle, is detected.

Also advantageously, the supervision system 16 is able to command the operation of the management unit according to the second operating mode only in the zones or sections where a non-communicating vehicle, smaller than the predetermined threshold, is detected.

The operation of the control system 12 will now be described in reference to an example use, in particular illustrated by FIGS. 4 to 7.

In the example of FIGS. 4 to 7, a communicating vehicle and a non-communicating vehicle circulate in the network 10.

For example, initially, the non-communicating vehicle T2 enters the third section 36 and the non-communicating vehicle T2 passes the end terminals 34B, 36A. The entry of the non-communicating vehicle T2 in the third section 36 and its exit from the second section 34 is detected by the secondary detection system.

The axle counter 40 positioned at the third downstream end terminal 36A for example detects the passage of the set of axles of the non-communicating vehicle T2.

According to the example of FIG. 4, the axle counter 40 positioned at the third downstream end terminal 36B delimits one end 60 of the track 30, past which the vehicles cannot move.

Alternatively, the axle counter 40 positioned at the third downstream end terminal 36B delimits the third section 36 relative to a following section on which the vehicles are able to circulate. No vehicle T1, T2 has been detected in the following section, which is therefore in the “free” state.

The non-communicating vehicle T2 is then for example stopped in the third section 36, which is a garage/storage zone of the vehicle in the example of FIGS. 4 to 7.

As long as the secondary detection system has not detected the exit of the non-communicating vehicle T2 from the third section 36, the zone controller 26 knows that the non-communicating vehicle T2 in question is in the third section 36. In other words, in the considered example, as long as the non-communicating vehicle T2 has not completely passed the axle counter 40 positioned at the third upstream end terminal 36A to enter the second section 34, the control system 16 knows that the non-communicating vehicle T2 in question is in the third section 36.

The second protection zone 55 associated with the non-communicating vehicle T2 for example has an initial length Li.

The initial length Li is greater than or equal to the length of the third section 36.

The second protection zone 55 includes the third section 36.

For example, the second protection zone 55 covers the third section 36 and a portion of the preceding second section 34.

In the example of FIG. 4, a communicating vehicle T1 circulates on the first section 32 toward the second and third sections 34 and 36. The zone controller 26 determines a first protection zone 50 of the communicating vehicle T1 and has stored the position of a third protection zone, not shown, between the first protection zone 50 and the first downstream end terminal 32B. The presence of such a third protection zone is for example related to an error by the axle counter 40 positioned at the first downstream end terminal 32B.

When the communicating vehicle T1 approaches the first downstream end terminal 32B, the supervision system 16 commands the zone controller 26 into the first operating mode M1 for the first and second sections 32 and 34.

The movement of the communicating vehicle T1 then comprises a discrimination step.

More specifically, in the example of FIG. 4, the zone controller 26 calculates the distance D between the communicating vehicle T1 and the first downstream end terminal 32B. The second section 34 being unoccupied and the distance D being smaller than or equal to the predetermined threshold, the zone controller 26 considers that no obstacle is interposed between the communicating vehicle T1 and the first downstream end terminal 32B. The third protection zone between the communicating vehicle T1 and the end terminal 32B is then eliminated at the zone controller 26 and in particular the management unit.

The discrimination step then allows the zone controller 26 to determine the absence of vehicle between the communicating vehicle T1 in question and the first downstream end terminal 32B.

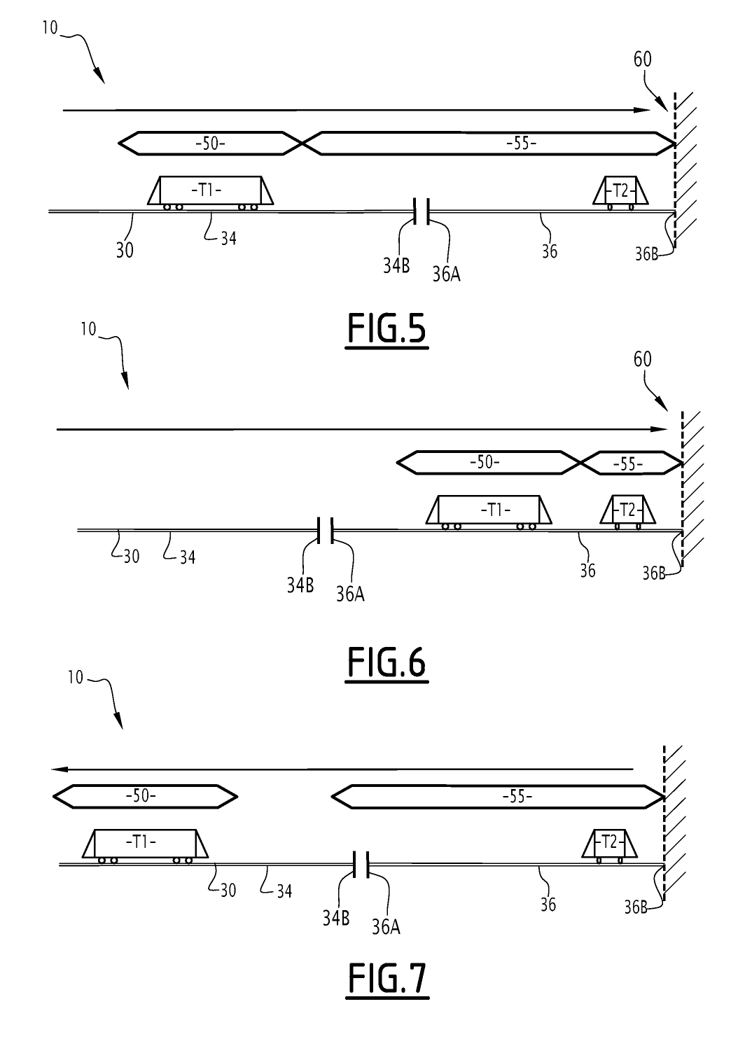

Next, as shown in FIGS. 5 and 6, the communicating vehicle T1 approaches the second protection zone 55 associated with the non-communicating vehicle T2. The zone controller 26 for example commands the braking of the communicating vehicle T1 so that the communicating vehicle T1 approaches the non-communicating vehicle T2 with a predetermined maximum speed.

Advantageously, the management unit of the zone controller 26 recalculates the size of the second protection zone 55 in order to decrease its size and reduce the distance between the communicating T1 and non-communicating T2 vehicles in order to park the communicating vehicle T1 in the third section 36.

In particular, as shown in FIGS. 5 and 6, the length of the second protection zone 55 is modified when the distance between the third upstream end terminal 36A and the communicating vehicle is smaller than the length of the second protection zone 55.

This modification makes the length of the second protection zone 55 smaller than or equal to a final distance between the third downstream end terminal 36B and the communicating vehicle T1 and larger than the length of the non-communicating vehicle T2.

In other words, the management unit of the zone controller 26 for example excludes, from the second protection zone 55, the portions of the track that do not contain an obstacle to the movement of the vehicles T1, T2.

Alternatively, the communicating vehicle T1 is controlled manually to come closer to the non-communicating vehicle T2 and the zone controller 26 recalculates the size of the second protection zone 55 based on the movement of the two vehicles T1, T2 relative to one another.

In the case of FIG. 6, the communicating vehicle T1 approaches the second protection zone 55.

The zone controller 16 recalculates the size of the second protection zone 55, using a procedure known in itself, to bring the communicating vehicle T1 into a storage position close to the non-communicating vehicle T2.

When the communicating vehicle T1 comes closer to the non-communicating vehicle T2, and in particular when the communicating vehicle T1 enters the third section 36, which already includes the non-communicating vehicle T2, the supervision system 16 commands the zone controller 26 into the second operating mode M2 for the third section 36 advantageously through the action of an operator. In other words, the control system 12 switches into the second operating mode M2.

More generally, the operating mode of the zone controller 26 is specific to each section, preferably each zone, and is therefore able to be different for each section, preferably each zone.

The second operating mode M2 inhibits the implementation of the discrimination step and prevents any suppression of the second protection zone 55 associated with the non-communicating vehicle T2.

Owing to the command of the zone controller 26 in the second operating mode M2, in the third section 36, when the communicating vehicle T1 leaves the third section 36, for example after having been parked overnight in the third section 36, the second protection zone 55 is preserved and, advantageously, the length of the second protection zone 55 is brought back to the initial length Li based on the movement of the communicating vehicle T1.

In particular, when the communicating vehicle T1 leaves the third section 36, as shown in FIG. 7, the length of the second protection zone 55 is brought back to the initial length Li. Furthermore, the control system 12 then switches from the second operating mode M2 to the first operating mode M1.

Such a method makes it possible to limit the risks of collision between the non-communicating vehicle T2 and the other vehicles while preserving the operation of the zone controller 26 according to the first operating mode M1 in the sections where the presence of non-communicating vehicles T2 is not detected.

The circulation management method is therefore a method allowing a more optimized management of the circulation of vehicles based on the type of vehicles present on the network 10, in particular in terms of safety.

In particular, such a method allows the cohabitation of maintenance vehicles and communicating vehicles with minimal exported constraints.

Advantageously, each time the non-communicating vehicle T2 enters a section 32, 34, 36, the supervision system 16 commands the operation of the zone controller 26 for said section 32, 34, 36 into the second operating mode M2.

The above examples are described in the case where the vehicles are railway vehicles and the network 10 is a railway network. It should be noted that different types of networks may be used.

In order to stay in a safe mode, the preferred embodiment is to stay in operating mode M2 at all times and to activate operating mode M1 only when the control system 12 has unduly positioned a protection zone 55 for a train that is not present. When verifications confirm that this vehicle is not present, the operator may ask the supervision system 16 to switch the section in question to operating mode M1.

According to one embodiment, the network is a road network. In this case, the vehicles are road vehicles such as buses.

1. A method for controlling the circulation of communicating and non-communicating vehicles in a network, the network comprising tracks divided into a set of sections 2, 34, 3, each delimited by two end terminals, beacons and track sensors, the set of track sensors forming a secondary detection system,
each communicating vehicle being provided with an active on board position detection device, called primary detection device, the primary detection device forming, with the beacons, a primary detection system,
each non-communicating vehicle being a vehicle with no primary detection device,
the network being controlled by a control system able to manage the circulation of the communicating vehicles on each section according to a first operating mode, associating a first protection zone with each communicating vehicle, the location of the first protection zone depending on a position of the communicating vehicle defined by the primary detection system, and associating a second protection zone with each non-communicating vehicle, the location of the second protection zone depending on a position of the non-communicating vehicle defined by the secondary detection system,
the first operating mode managing the movement of the communicating vehicle toward the end terminal of a first section in which a non-communicating vehicle has been detected by implementing a discrimination step, the discrimination step eliminating any protection zone located between the communicating vehicle and one of the end terminals of a free vehicle section toward which the communicating vehicle moves, when a distance between the communicating vehicle and said end terminal is smaller than or equal to a predetermined threshold, the method comprising a step for:
switching the control system into a second operating mode, when the communicating vehicle enters the first section, the second operating mode inhibiting the implementation of the discrimination step at least in the first section.

2. The method according to claim 1, wherein the second protection zone associated with each non-communicating vehicle includes the first section in which the non-communicating vehicle was detected.

3. The method according to claim 1, wherein a minimum length is defined for the set of communicating vehicles, the predetermined threshold being below the minimum length.

4. The method according to claim 1, wherein, during the movement of the communicating vehicle, the length of the second protection zone is modified when the distance between an upstream end terminal of the first section and the communicating vehicle is smaller than the length of the second protection zone, the modification making the length of the second protection zone smaller than or equal to a final distance between a downstream end terminal and the communicating vehicle and larger than the length of the non-communicating vehicle.

5. The method according to claim 4, wherein in the second operating mode, when the communicating vehicle leaves the first section, the length of the protection zone is brought back to an initial length and the method comprises a step for switching from the second operating [mode] to the first operating mode.

6. The method according to claim 1, wherein a downstream end terminal of the first section:
delimits the first section and a second section, no vehicle having been detected in the second section, or
delimits an end of a track.

7. The method according to claim 1, wherein the non-communicating vehicle has a length smaller than or equal to half of a length of the communicating vehicle.

8. The method according to claim 1, wherein the first and second operating modes are managed section by section.

9. An assembly made up of a network, at least one communicating vehicle and at least one non-communicating vehicle, the network comprising tracks divided into a set of sections each delimited by two end terminals, beacons and track sensors, the set of track sensors forming a secondary detection system, each communicating vehicle being provided with an active onboard position detection device, called primary detection device, the primary detection device forming, with the beacons, a primary detection system, each non-communicating vehicle being a vehicle with no primary detection device, the network being controlled by a control system able to manage the circulation of the communicating vehicles on each section according to a first operating mode, associating a first protection zone with each communicating vehicle, the location of the first protection zone depending on a position of the communicating vehicle defined by the primary detection system, and associating a second protection zone with each non-communicating vehicle, the location of the second protection zone depending on a position of the non-communicating vehicle defined by the secondary detection system,
the first operating mode managing the movement of the communicating vehicle toward the end terminal of a first section in which a non-communicating vehicle has been detected by implementing a discrimination step, the discrimination step eliminating any protection zone located between the communicating vehicle and one of the end terminals of a free vehicle section toward which the communicating vehicle moves, when a distance between the communicating vehicle and said end terminal is smaller than or equal to a predetermined threshold, the control system being configured to switch into a second operating mode, when the communicating vehicle enters the first section, the second operating mode inhibiting the implementation of the discrimination step at least in the first section.

10. The assembly according to claim 9, wherein the control system comprises a supervision system, the supervision system providing the switching into a second operating mode when the communicating vehicle enters the first section.
